(19) United States
(12) Patent Application Publication
(10) Pub. No.: US 2004/0215518 A1
(43) Pub. Date: Oct. 28, 2004

(54) System and method for targeted advertising and marketing

(75) Inventor: Fatehali Dharssi, Vancouver (CA)

Correspondence Address: Keyvan Davoudian, PILLSBURY WINTHROP LLP, Suite 2800, 725 South Figueroa Street, Los Angeles, CA, 90017-7100, US

(73) Assignee: DSD COMMUNICATIONS, INC.

(21) Appl. No.: 10/852,338

(22) Filed: May 24, 2004

Related U.S. Application Data
(63) Continuation-in-part of application No. 10/083,901, filed on Feb. 27, 2002.
Application No. 10/083,901 is a continuation-in-part of application No. 09/689,540, filed on Oct. 12, 2000, now Pat. No. 6,421,986.

(51) Int. Cl. G06F 17/60; A23B 4/00; B65B 55/00

(52) U.S. Cl. 705/14

(57) ABSTRACT

A method for distributing promotional material, which may be practiced as a fully-automated process, calls for the use of packages of bread products, such as sliced/unsliced bread, hamburger/hotdog buns, tortillas, etc. as unique vehicles for retailer-specific targeting of promotional material. The invention achieves its objectives by connecting a network of entities and computer systems, wherein information regarding bakeries' production schedules, specific retailers' purchase orders, and advertisers' specifications are collected and processed to provide instructions for bagging and/or coupon-targeting systems to include specified wrappers and promotional material with each bread product or groups of bread products. For each package of bread, the promotional material may be included inside the bread bag or wrapper, outside of the bread wrapper, or both. A cart-marking system ensures that each retailer's order is placed on a separate cart, with the packages of bread carrying promotional material that is tailored for that retailer.

### RELATED APPLICATION DATA

This is a continuation-in-part of application Ser. No. 10/083,901, filed Feb. 27, 2002, which is a continuation-in-part of application Ser. No. 09/689,540, filed Oct. 12, 2000, now U.S. Pat. No. 6,421,986.

### BACKGROUND OF THE INVENTION

1. Field of the Invention

This invention is in the field of marketing and promotional advertising and, more particularly, directed to an automated, networked system and method for providing promotional material, such as coupons, advertisements, samples, food recipes, publications, informational sheets, and other promotional items, such as refrigerator-door magnets, in combination with single or multiple packages of a bread product, such as sliced bread, hamburger buns, hot dog buns, unsliced bread, tortillas, etc., on a retailer-specific basis, in such a way as to capitalize on the specific retailer's customer traffic in an efficient and cost-effective manner.

2. Art Background

Product “couponing” dates back to the late 1890's, when C.W. Post developed penny tokens that were redeemable on his then new “Grape-Nuts” breakfast cereal. Realizing the effectiveness of couponing as a means to generate trial, as well as encourage repeat purchases, companies such as Coca Cola, Procter & Gamble, and Hershey quickly adopted this marketing innovation. Today, couponing is the dominant promotion marketing tool employed by consumer-driven companies to stimulate consumer behavior in multiple channels of distribution. Whereas, at one point in time, couponing was employed almost exclusively by the consumer package goods (CPG) industry, it is now utilized extensively by companies such as Blockbuster Video, Pizza Hut, and Lenscrafters.

Currently, the predominant methods of coupon delivery are Shared Mail, which delivers national and local coupons wrapped in a supermarket retailer's weekly flyer, direct mail and Sunday Free Standing Inserts (FSI), which are four color, multi-page inserts distributed through Sunday newspapers. Currently, couponing is dominated by FSIs, which were introduced in 1972. In 1999, FSIs accounted for 92% of the 288 billion coupons distributed, as well as 71% of all redemptions.

However, the shear number of coupons distributed provides only a partial indication of the level of success achieved by any couponing scheme; success also depends on the frequency with which the distributed coupons are actually redeemed by consumers. In this regard, while the FSI share of distribution has increased slightly since the mid-1990's, declining coupon redemption rates have led advertisers to explore alternative avenues to improve cost efficiency and effectiveness. As such, in the past several years, coupon distribution has declined as the search for more effective promotional schemes has prompted marketers to divert promotional spending from FSIs and redirect it towards targeted, in-store methods in order to reach consumers who are most likely to use coupons, as well as those users who are amenable to product trial and brand switching.

As alternative marketing strategies have been sought, numerous new advertising schemes have been introduced (and, in some cases, subsequently vanished) over the past several years. These include (1) Co-op direct mail programs, which can be divided into two categories, i.e., shared and consumer direct; (2) “electronic shelf”, featuring four color coupons that are distributed at the shelf via a plastic dispenser in supermarkets and drug/mass merchandiser outlets; (3) “electronic checkout”, where coupons are issued at supermarket checkout based upon competitive, complimentary, or like product scanned; (4) “in-pack/on-pack” couponing, where coupons are inserted in or on product packages by CPGs and are usually redeemable on a subsequent purchase of the same product and occasionally a complimentary product; (5) “instant redeemable coupons”, which are on-pack coupons that are affixed to product packages and designed such that consumers can remove them at a retailer's shelf for immediate redemption; (6) newspaper R.O.P., which involves coupons printed as part of the redirect paper or flyer itself, and can be executed as a co-op or on a solo basis; (7) magazine couponing, which is normally executed on a solo basis, but may be included as a four-color pop up insert in selected magazines; (8) “interactive coupons”, which typically rely upon kiosks for distribution; (9) “XtraValu” coupons, where CPG coupons have been distributed in “saddlebag” pouches that are placed over the neck of one-gallon milk containers; (10) “Egg coupons”, where multi-folded coupons are inserted into cartons of eggs—this program eventually failed due to inconsistent retailer coverage, limited reach, and coupon damage caused by cracked eggs; (11) “off-the-shelf” couponing, which utilizes disposable shelf dispensers; (12) “Ad-Strip”, where two- and four-color coupons are printed on the gusset strip of supermarket and department store plastic shopping bags; and (13) internet coupons.

Still, FSI's and shared mail continue to dominate because they provide advertisers with a promotion and advertising medium that delivers broad reach at an affordable rate. On the other hand, both of these coupon-delivery methods suffer from at least two major weaknesses: they do not have an in-store presence and they deliver low redemption rates.

The features and advantages of the present invention will become more apparent through the following description. It should be understood, however, that the detailed description and specific examples, while indicating particular embodiments of the invention, are given by way of illustration only and various modifications may naturally be performed without deviating from the spirit of the present invention.

### BRIEF DESCRIPTION OF THE DRAWING

FIG. 1 shows an illustration of communication links established among entities and/or electronic computers that may be used in the practice of an embodiment of the present invention.

### DETAILED DESCRIPTION

In this application, the terms “coupon” or “coupons” are used from time to time as an example of, or synonymously with, “promotional material” or “advertising material”. However, such use is by way of example, and for ease of reference, only, and not by way of limitation. In addition, the terms “bread” or “bread product” are used by way of example, and in order to facilitate the description, and not by way of limitation. Thus, “bread” or “bread product” may refer to a loaf of bread (e.g., sliced, unsliced, etc.), buns (e.g., hamburger buns, hot dog buns, etc.), tortillas (e.g., flat, shaped, etc.), and other bread products.

An embodiment of the present invention is directed to a method of targeted advertising of particularized goods and/or services, whereby one or more pieces of targeted promotional material are included with a package of bread shortly prior to, during, or shortly after, placement of the bread into the package. The pieces of promotional material generally fall into a plurality of categories, including, without limitation: (1) retailer-specific coupons (e.g., coupons that are offered by, and are redeemable in, SafeWay stores in the Los Angeles area, for products that generally complement bread); (2) national coupons that are redeemable only at the same specific retailer (e.g., coupons from Tide, Kraft Foods, or Nabisco, which may be redeemed only at SafeWay stores in the Los Angeles area); (3) advisory materials (e.g., health-related material or “tip” sheets, informational material, recipes, advertising material from other businesses or organizations within the Los Angeles area, and other similar information appearing in textual format); (4) product samples; and (5) other promotional items (e.g., refrigerator-door magnets that carry advertisements and may be used to hold up the above-mentioned “tip” sheets).

An embodiment of the present invention is also related to a method of distributing promotional material, in which bread is used as a vehicle to deliver bread packages with specific promotional materials to specific retailers (i.e., retail stores, or stores). In one embodiment, this is achieved by creating a computerized network that enables electronic transmission of information among bread delivery route drivers, central and localized bread-making facilities, advertisers/retailers, and a central system operator. This information, which may include daily bread orders for each retailer, production schedule for each bread-making facility, coupon specifications from each advertiser, etc. is collected and used by the system operator and/or the bread-making facility to generate instructions. The latter are then used to coordinate the operation of several systems, including bread-bagging, coupon-targeting, and cart-marking systems, within the baking-bagging/couponing-delivery process, thus allowing targeted advertising to specific retailers using packages of bread as the “delivery vehicle”.

In its various embodiments, the present invention offers several advantages. First, it allows the specific retailer for whom the bread is being made and packaged (e.g., SafeWay, Giant, etc.) to obtain information about which specific national and/or store brands are to be promoted. In a preferred embodiment, the coupon is only redeemable at the issuing chain. This, in turn, allows the retailer to estimate the demand for, and maintain an adequate stock of, the items that have been promoted. In addition, the invention encourages repeat traffic into the retailer's store. This is especially true when the coupon is store/chain specific. Moreover, the invention increases coupon security by nearly eliminating instances of fraudulent redemption of the type that is prevalent with newspaper, or similar loose, couponing schemes. For example, it is believed that some small storeowners have clipped coupons and submitted them for redemption even though the coupon was not presented by a customer and no sale actually took place.

In achieving its objectives, the present invention takes advantage of several qualities that are unique to bread as a vehicle for advertising. First, because bread is generally shipped by bulk, and not by weight, the inclusion of promotional material with the bread bag does not increase shipping costs. This is to be contrasted with traditional means of advertising (e.g., through newspapers), where there is a cost associated with the distribution of promotional materials (e.g., cost of postage and/or cost of insertion of coupons in a newspaper).

Second, from a practical standpoint, bread is dry, so that there is no damage to the promotional material from being packaged with the bread. Third, as a commodity, bread is not in competition with most other goods/products. Fourth, in contrast with other goods/products, almost everybody buys bread, with quite regular frequency. Fifth, in contrast with newspapers, mailings, etc., a package of bread usually ends up, and is opened, in the kitchen. This is normally an uncluttered environment which provides for maximum exposure with minimum distraction. Similar to a Sunday newspaper, the present invention permits “mass media” distribution of coupons in a short period of time, and at a relatively low cost.

Finally, the specific type of bread can be used to fine-tune a retailer-specific targeting scheme so as to target store/region-specific consumers, referred to as “targeted groups”, which have been determined to be the most likely users of the product being advertised. Thus, for example, coupons for cheese may be included with bags of white sliced bread, and coupons for hot dogs may be included with bags of hot dog buns, both of which are directed at children. Similarly, coupons for health foods may be included with bags of whole-wheat bread, which would be directed at the health-conscious consumer. These and other buying characteristics (age, sex, income, preference of bread type, etc.) are also within the scope of the invention.

Once the targeted group is identified, the relevant set of coupons can be included with packages of bread that are delivered to the retailer(s) servicing the targeted group. In one embodiment, retailer-specific targeting is facilitated by creating a network, such as a computerized, electronic network, whereby information relating to the types and quantity of bread sold through each retailer is used to automatically generate a retailer-specific coupon-distribution scheme.

A typical bread-distribution process according to the current state of the art may be described as follows: A route driver delivers packages of bread to specific retailers according to a delivery schedule. At each stop, the route driver gathers information, e.g., by inputting such information into a hand-held computer, about the types and respective quantities of bread to be delivered to that specific retailer the next day. This serves as a “purchase order” for each specific retailer. At the end of the day, this information is transmitted either to a specific, local bakery, or to a centralized headquarters which coordinates the operation of several local or regional bakeries. Alternatively, the information, or “purchase order”, may also be transmitted directly to the specific bakery/centralized headquarters by each retailer or from the retailer's headquarters.

Based on the purchase orders received (e.g., from each one of several route drivers, from the retailer itself, etc.), each local bakery generates a bread-production schedule for the following day. Thus, as an example, local bakery A may receive orders from route drivers 1 through 5 as follows: (1) route driver 1: 300 bags of sliced white bread and 150 bags of sliced wheat bread; (2) route driver 2: 500 bags of sliced white bread; (3) route driver 3: 200 bags of sliced white bread and 100 bags of sliced wheat bread; (4) route driver 4: 100 bags of sliced white bread and 300 bags of sliced wheat bread; and (5) route driver 5: 100 bags of sliced wheat bread, for a total of 1100 bags of sliced white bread and 650 bags of sliced wheat bread.

Thus, according to the above orders, Bakery A will arrange to prepare 1100 bags of sliced white bread and 650 bags of sliced wheat bread for pick up and delivery by route drivers 1-5 the following day. Once prepared, all of the bags of sliced white bread are placed on trays which, in turn, are placed in carts containing only white bread. Similarly, all of the bags of sliced wheat bread are placed on trays and in carts containing only wheat bread. The next morning, each route driver arrives at Bakery A and counts and takes as many trays/carts as are needed to fill his orders for each type of bread.

The present invention improves upon the above-described process by creating a network, wherein the information collected by the route drivers (and/or otherwise provided directly by the retailer) is used by the baking facilities to determine the type of wrapper (e.g., Webers, or Safe Way brand) that is to be used to bag each bread product. In addition, this information is transmitted to a central system operator and, along with information and specifications received from advertisers, is used to: (1) set the number and type of advertising materials that are to be included with each package of bread (i.e., according to the specific retail store for which the package of bread is destined); and (2) mark individual trays and/or carts according to each route driver's purchase orders such that one or more trays/carts are prepared and identified for delivery to each specific retail store. In this way, on any given day, route driver 1, e.g., transmits his purchase orders to the baking facility's central and/or onsite computer system, and merely returns the next day to pick up trays/carts that are filled up (according to router driver 1's purchase orders) and marked for delivery to each of the retailers serviced by route driver 1.

Thus, according to one aspect of the invention, store-by-store coupon targeting is made possible by including advertising material with packages of bread in accordance with the number and/or types of bread sold by each store, and according to a second aspect of the invention, the determination as to the number and types of advertising material to be included with each package of bread is made by collecting and processing information from advertisers and route drivers, and then coordinating with each baking facility's production schedule. It is noted that the purchase order information may be provided directly by a retailer, rather than through a route driver.

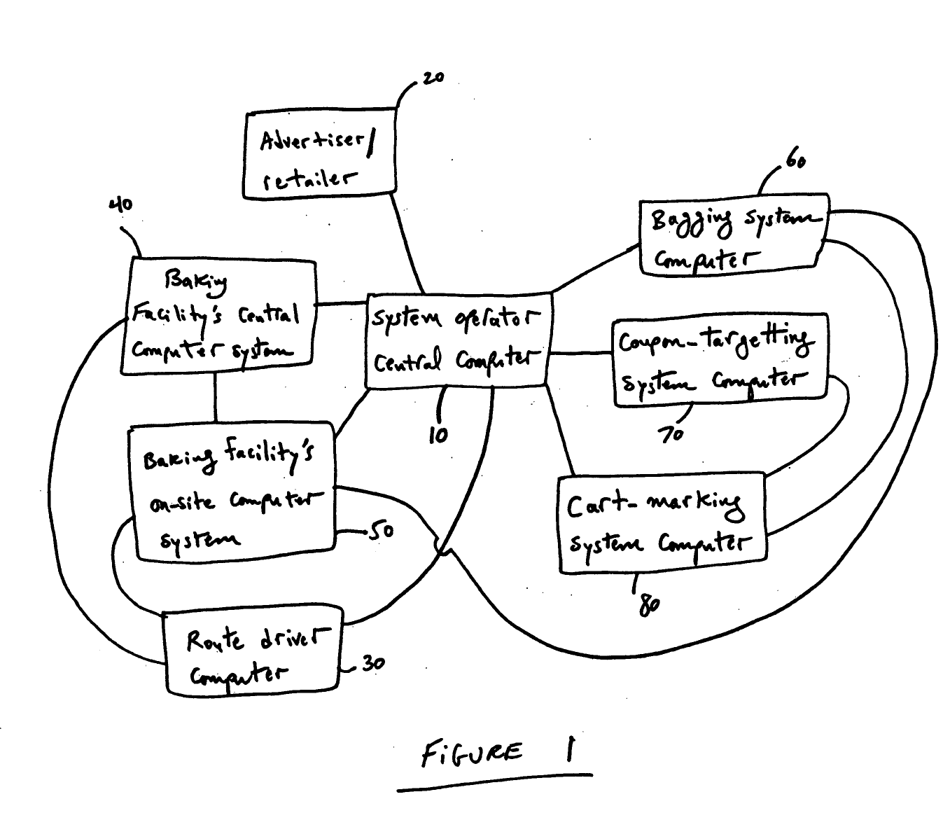

As shown in FIG. 1, the present invention involves the flow of information among several entities, including: (1) a system operator having a system operator central computer 10; (2) one or more advertisers and/or retailers, generally referred to as “clients”, having one or more computers 20; (3) one or more bread-baking and packaging facilities, generally referred to as “bakeries”, each such bakery having an onsite computer 50; (4) the bakery's headquarters having a central computer system 40; (5) one or more route drivers having (usually) hand-held computers 30; (6) a bagging system located at the bakery and having a computer 60; (7) a coupon-targeting system located at the bakery and having a computer 70; and (8) a tray/cart marking system having a computer 80.

As shown in FIG. 1, the several systems are electronically linked. Thus, for example, the bakery's onsite computer, the system-operator central computer, the coupon-targeting system computer, and the bagging system computer operate in concert to produce a certain number of bags of bread (which may be private branded for a specific retailer), of a certain type of bread, with certain types and quantities of promotional materials accompanying each bag. Moreover, information is transferred among the several systems/system computers as electronically-transmitted data records and/or instructions.

The process starts with the system operator 10 receiving promotional specifications from its clients 20. Client specifications generally relate to instructions for printing coupons, tip sheets, and other textual material, and include such information as coupon (i.e., discount) amount, the identity and location of a retailer where a coupon may be redeemed (e.g., Los Angeles SafeWay Stores), the identity of a specific product or service that is advertised (e.g., Kraft sliced cheese, or SafeWay's own brand peanut butter), and other similar information. Client specifications may also include instructions for the inclusion of product samples, or other promotional items, with the printed material.

In one embodiment, the system operator 10 prints the coupons and inserts them in one or more envelopes, or packets, and forwards them to the bakery for use on a store-by-store, chain-by-chain, and/or region-by-region basis. In another embodiment, an employee stationed at the bakery organizes the promotional material onsite (e.g., by physically printing, preparing, and/or receiving the coupon packets). The system operator may also engage a third party for the printing of the coupons and preparation of the packets, etc., based on the promotional specifications/instructions received from the client, which packets are then forwarded directly to the bakery.

The client's specifications define, e.g., the number and types of promotional materials that each client would like to have included with each specific package of bread. As an example, on a given day, SafeWay may direct the system operator to include a coupon offering a $0.20 discount on SafeWay brand peanut butter with every package of white sliced bread that is going to be delivered to specific Los Angeles county SafeWay stores, and a coupon offering a $0.40 discount on SafeWay brand peanut butter with every package of white sliced bread that is going to be delivered to specific Orange County SafeWay stores. In addition, Kraft Foods may instruct the system operator to include a $0.35 coupon for Kraft cream cheese with each package of bread that is destined for the specific Los Angeles county SafeWay stores, as well as a $0.50 coupon for Kraft cream cheese with each package of bread that is destined for the specific Orange county SafeWay stores.

A third specification may be provided by a chef/author (who is promoting a book of recipes, e.g.) who instructs the system operator to include with each package his recipe for making quick and healthy snacks for children. As noted above, these three coupons are inserted into a packet, and multiple packets are then grouped and/or marked on a store-by-store, chain-by-chain, and/or region-by-region basis.

As was described previously, on at least a daily basis, each route driver transmits a purchase order (for each retailer serviced by the route driver) to the bakery's central computer system 40, indicating at least the number and types of bread that are to be dropped off to each retailer on the route driver's next stop. From time to time, the bakery's central computer system may change the required quantity and/or type of bread requested in order to accommodate production schedules, etc. Once finalized, this information is then transmitted (e.g., as a set of instructions) to the system operator central computer 10, and/or the bakery's onsite computer 50. In alternative embodiments, the information from the router driver's computer 30 may be communicated directly to the system operator central computer 10, and/or the bakery's onsite computer 50.

In one embodiment, the system operator central computer 10 communicates with the bakery's onsite computer 50 in order to retrieve the daily production schedule for each bakery. In some applications, however, the bakery's central and onsite computer systems may be one and the same, such that information regarding daily production schedules, as well as the route driver's purchase order information, are transmitted from the same system to the central computer of the system operator.

Having each route driver's purchase order information, each bakery's production schedule, and each client's specifications, the system operator can now coordinate the store-specific coupon-targeting process, in conjunction with the bagging system 60, coupon-targeting system 70, and cart-marking system 80 that are located at each local bakery.

As an example, the system operator may determine that, according to route driver A's purchase orders, retail store B will require a large number of sliced white bread packages. At the same time, client C's (e.g., Safe Way's) specifications may indicate that a coupon offering a $0.20 discount on SafeWay brand peanut butter should be included with every package of sliced white bread that is going to be delivered to retail store B on a given day. In addition, client D's (e.g., Kraft Foods') specifications may instruct the system operator to include a $0.35 coupon for Kraft cream cheese with the same package of bread, going to the same retail store B.

The system operator central computer then checks the production schedule for bakery E (i.e., one or more bakeries that may service retail store B) to determine whether store B is supposed to have sliced white bread delivered the next day. If it is, then the system operator central computer determines the number of packages of sliced white bread that are to be delivered from bakery E to store B the next day and, based on this information, generates and transmits a set of instructions to a coupon-targeting system computer 70 that is located at bakery E.

The coupon-targeting system is the system (e.g., a carousel and magazine system, a tray, a side-by-side or multi-tiered magazine system, etc.) through which one or more packets of coupons are included with each package of bread. To this end, the coupon-targeting system computer controls the operation of the coupon-targeting system by providing information and operational instructions relating to the type and number of packets of coupons that are to be included with each package of bread.

In certain embodiments, client C's (i.e., Safe Way's) specifications may indicate that the coupons offering a $0.20 discount on SafeWay brand peanut butter should be included only with packages of sliced white bread that are going to be bagged with Safe Way brand wrappers. At the same time, client D's (i.e., Kraft Foods') specifications may instruct that the coupons offering a $0.35 savings on Kraft cream cheese be included only with packages of sliced white bread that are going to be bagged with Wonder Bread brand wrappers. In such a case, the system operator central computer 10 generates and transmits (based on the above information) a set of instructions to a bagging-system computer 60 that is located at bakery E.

In this manner, operation of the bagging system 60 and the coupon-targeting system 70 is coordinated such that for each package of bread, the bagging-system computer will instruct the bagging system as to which kind of wrapper to use for bagging each bread product, and the coupon-targeting system computer will instruct the coupon-targeting system as to the quantity and type of coupons to include with each specific package of bread. In certain applications, a line of communication may also be established between the baking facility's onsite computer system 50 and the bagging system computer 60. Additionally, it is important to note that, in one embodiment, the bagging system and the coupon-targeting system may be one and the same and, as such, their operation may also be controlled by one computer system.

In another aspect of the process, the system operator central computer 10 communicates with a cart-marking system computer 80 to ensure that the packages of bread carrying store-specific coupons are sent to the specific retail stores for which they were produced and intended. As its name implies, the cart-marking system generates identifying indicia, e.g., bar codes, that identify the specific retail store to which each cart is to be delivered by the appropriate route driver. Additional information, such as, e.g., the number of packages of bread to be loaded on each cart, the type of bread to be placed on each cart, etc. may also be included.

Thus, for example, when retail store B has requested 175 bags of sliced white SafeWay brand bread, the bagging system and the coupon-targeting system operate in conjunction with the cart-marking system (see FIG. 1) to ensure that 175 bags of sliced white SafeWay brand bread carrying packets of coupons designated for retail store B are loaded on one or more carts marked for delivery to store B and placed separately from other carts containing sliced white bread. This process is then repeated for each of the other retail stores which are serviced by the route drivers working with each bakery.

Thus, in this manner, when a route driver arrives at a bakery in the morning, he merely has to check for carts that are identified (e.g., bar-coded) for delivery to retailers that are on his route, and load those carts onto his truck for delivery to the retailers. It is important to note that, in one embodiment, individual trays within each cart may also be marked and, thus, targeted to specific retailers.

In one embodiment of the invention, the method may employ an optical bar-code reader, or similar device. In practice, each bread bag that is to be filled bears a bar code, or similar data (or indicia) that identifies the type of bread that is to be loaded (e.g., white bread) in that bag. The optical reader is placed each bag may be identified just prior to filling with bread.

Given that most bagging systems run at the speed of about 50 bags per minute, from a practical standpoint, it is sometimes difficult to achieve precision in every production run. More specifically, if, for example, 500 bags of white bread are going to be loaded, it may turn out that 503 bags are, in fact, filled. This would mean that 3 bags might have improperly received coupon packets that were not intended for those bags. Given this scenario, the optical reader, in electronic communication with the coupon-targeting system, helps ensure that the 501^{st} bag, which bears a different bar code or bears a different label or sticker than the 500^{th} bag, receives its own specialized packet, rather than a packet left over from the previous run.

In an embodiment of the invention, the method can include a bag-marking device. In this embodiment, once a package of bread has been filled and the proper packet of advertising materials included, the marking device marks the outside of each package with a label, flag, tag, or other similar attachment, that is color-coded for the major chains, and informs consumers of the contents of the packets (e.g., value of coupons that have been included with the bag). In this way, the marking device is used in the distribution of the bags and, thus, the promotional materials.

In another embodiment of the instant invention, multiple packages of bread are wrapped in a larger wrapper. In this embodiment, the store-specific targeting is achieved and/or enhanced by collaboration among the various entities and computer systems discussed above in order to include either: (1) a packet of coupons with each of the smaller bags only (i.e., a packet of coupons is included with at least one of the bags of bread, but not with the larger bag containing the two bags of bread); (2) a packet of coupons with the larger bag only (i.e., no packet of coupons is included with the bags of bread themselves); or (3) a packet of coupons with at least one of the bags of bread, as well as a packet of coupons with the larger bag. Thus, as an example, where two bags of bread are wrapped in a large wrapper, the entire package can be used to carry up to three (3) different packets of coupons, which greatly enhances the targeted marketing and advertising capabilities offered by the instant invention.

In yet another embodiment, the packet of coupons may be included inside each bag of bread by insertion into the bag at or about the time when each bread product is being wrapped. Thus, in a multi-bagging application of the type described immediately above, packets of coupons may be inserted in each of the bags of bread, as well as the larger wrapper enclosing the bags of bread.

In yet another embodiment, the packet of coupons may be affixed to the bread bag. In a preferred embodiment, a special, helical gluing pattern is employed to removably affix the packet to (e.g., the outer top of) the bread bag shortly after the bread has been loaded into the bag. As discussed previously, the packet may contain one or more items, including, but not limited to: (1) retailer-specific coupons; (2) national coupons that are redeemable only at the same specific retailer; (3) advisory materials; (4) product samples; and (5) other promotional items. Therefore, given the placement of the packet on the package of bread, in the instant embodiment, the size of the packet is configured such that, once affixed to the bread bag, it does not interfere with the overall production, delivery, and sales process.

Therefore, the dimensions of the packet are configured in such a way as to ensure that the package of bread carrying the packet will still fit into trays and/or carts that are normally used in the production and delivery processes. In addition, the dimensions of the packets are determined such that, once the packages of bread are delivered to a retail store, e.g., the bread bags will fit properly and without interference on the trays that are commonly used to transfer the bags from a delivery/storage area to a retail/sales area in the store. Similarly, the dimensions of the packets are configured so as to allow side-by-side and/or stack placement of the bread bags on retail shelves at the store.

Moreover, quite separate from the gluing pattern (i.e., helical), the type of glue that is used will depend on the type of bread that is being packaged. More specifically, the type of glue that is used will depend, at least in part, on the dimensions of the bread product that is being packaged, as well as the type of wrapper (i.e., bag, or package) material that is being used to bag the bread product. In addition, the specific type of glue, including application temperature and time, are chosen in such a way as to ensure that, on the one hand, the packet is sufficiently securely affixed to the bread bag so as not to become detached from the bag during the distribution process, and yet, on the other hand, the packet is not so strongly attached to the bag such that removal of the packet will tear the bag.

As before, the instant embodiment may be practiced in an application where multiple packages of bread are wrapped in a larger wrapper. Thus, a packet of coupons may be affixed to (e.g., an outer top or side of) each of the smaller bags only (i.e., a packet of coupons is affixed to at least one of the bags of bread, but not to the larger bag containing the two bags of bread). On the other hand, a packet of coupons may be affixed to the larger bag only, such that no packet of coupons is included with the bags of bread themselves. Alternatively, a packet of coupons may be affixed to at least one of the bags of bread, as well as to (e.g., an outer top or side of) the larger bag. Thus, where two bags of bread are wrapped in a large wrapper, the entire package can be used to carry up to three (3) different packets of coupons.

In yet another embodiment, multiple packets of coupons may be included with each bag of bread, wherein at least one packet is inserted into the bag (e.g., at or about the time when the bread product is being wrapped) and at least one packet is affixed to the bread bag (e.g., shortly after the bread product has been wrapped in the bag). In addition, multiple packaging of the type described above may be applied such that, where, e.g., two bags of bread are wrapped in a large wrapper, the entire package can be used to carry up to six (6) different packets of coupons.

It will be apparent to a person of ordinary skill in the art that embodiments of the present invention are not limited to specific embodiments disclosed herein. Thus, the present invention is intended to encompass all of the embodiments disclosed and suggested herein as defined by the claims appended hereto and any equivalents thereof.

What is claimed is:

1. A method for distributing promotional material with a package of bread from a baking facility in which the bread is baked and packaged, said method comprising:
a. providing a system-operator central computer for performing the steps of:
(i) electronically receiving promotional specifications for generating promotional materials on behalf of a client;
(ii) electronically receiving purchase-order information for a specific retailer;
(iii) generating, based on at least one of said promotional specifications and purchase-order information, a first set of instructions for packaging a bread product; and
(iv) generating, based on at least one of said promotional specifications and purchase-order information, a second set of instructions for including said promotional materials with said bread product;
b. transmitting said first set of instructions to a bagging-system computer at the baking facility, wherein said bagging-system computer uses said first set of instructions to automatically control the operation of a bagging system located at the baking facility; and
c. transmitting said second set of instructions to a coupon-targeting system computer, wherein said coupon-targeting system computer uses said second set of instructions to automatically control the operation of a coupon-targeting system located at the baking facility.

2. The method of claim 1, wherein the coupon-targeting system uses said second set of instructions to automatically include at least one packet with said package of bread based on one or more factors selected from the group consisting of the specific type of bread product to be packaged, the specific wrapper to be used for packaging the bread product, and a retail destination of said package of bread, said at least one packet containing one or more pieces of said promotional materials.

3. The method of claim 2, wherein said at least one packet is removably affixed to the outside of said package of bread.

4. The method of claim 3, wherein said package of bread is placed on a cart for delivery to said specific retailer having a specific retail destination, and wherein the system-operator central computer further generates a third set of instructions for transmission to a cart-marking system computer at said baking facility, said cart-marking system computer using said third set of instructions to generate an identification mark to be placed on said cart.

5. The method of claim 4, wherein said identification mark includes information indicating one or more members selected from the group consisting of the number of bread packages to be placed on said cart, the type of bread product to be placed on said cart, the brand of bread to be placed on said cart, and the retail destination for said cart.

6. The method of claim 5, wherein the identification mark is a bar code.

7. The method of claim 1, wherein, based on input data relating to production and demand, an onsite computer at the baking facility generates a fourth set of instructions reflecting the baking facility's daily production and packaging schedule, and the operation of each of said bagging system and said coupon-targeting system is further based on said fourth set of instructions.

8. The method of claim 1, wherein, based on input data relating to production and demand, a baking facility central computer system generates a fourth set of instructions reflecting the baking facility's daily production and packaging schedule, and the operation of each of said bagging system and said coupon-targeting system is further based on said fourth set of instructions.

9. The method of claim 1, wherein the promotional specifications are electronically transmitted from the client's computer.

10. The method of claim 1, wherein the purchase-order information is transmitted from a route driver's computer.

11. The method of claim 1, wherein the first set of instructions includes data to specify the wrapper to be used for bagging the bread product.

12. The method of claim 1, wherein, according to said first set of instructions, a plurality of bread products are enclosed within respective, individual wrappers so as to result in a plurality of separate packages of bread, and two or more of said plurality of separate packages of bread are enclosed within an additional wrapper.

13. The method of claim 12, wherein said second set of instructions includes instructions for the coupon-targeting system to include promotional materials with each of said plurality of separate packages of bread.

14. The method of claim 13, wherein the location of said promotional materials is selected from the group consisting of: (a) inside of at least one of said separate packages of bread; (b) on the outside of the wrapper of at least one of said separate packages of bread; and (c) combinations thereof.

15. The method of claim 14, further comprising including additional promotional materials with said additional wrapper.

16. The method of claim 15, wherein said additional promotional materials are placed either inside said additional wrapper, outside of the additional wrapper, or both inside and outside of the additional wrapper.

17. The method of claim 12, wherein said second set of instructions includes instructions for the coupon-targeting system to include promotional materials with said additional wrapper.

18. The method of claim 17, wherein said promotional materials are placed either inside said additional wrapper, outside of the additional wrapper, or both inside and outside of the additional wrapper.

19. A method for distributing promotional material with a package of bread from a baking facility in which the bread is baked and packaged, said method comprising:
a. providing a system-operator central computer for performing the steps of:
(i) receiving promotional specifications for generating promotional materials on behalf of a client;
(ii) receiving purchase-order information for a specific retailer;
(iii) generating, based on at least one of said promotional specifications and purchase-order information, a first set of instructions for packaging a bread product; and
(iv) generating, based on at least one of said promotional specifications and purchase-order information, a second set of instructions for including said promotional materials with said bread product;
b. transmitting said first set of instructions to a bagging-system computer at the baking facility, wherein said bagging-system computer uses said first set of instructions to automatically control the operation of a bagging system located at the baking facility; and
c. transmitting said second set of instructions to a coupon-targeting system computer, wherein said coupon-targeting system computer uses said second set of instructions to automatically control the operation of a coupon-targeting system located at the baking facility,
wherein the coupon-targeting system uses said second set of instructions to automatically insert a first packet into said package of bread and removably affix a second packet to the outside of the package of bread based on one or more factors selected from the group consisting of the specific type of bread product to be packaged, the specific wrapper to be used for packaging the bread product, and a retail destination of said package of bread, each of said first- and second packets containing one or more pieces of said promotional materials.

20. The method of claim 19, wherein said package of bread is placed on a cart for delivery to said specific retailer having a specific retail destination, and wherein the system-operator central computer further generates a third set of instructions for transmission to a cart-marking system computer at said baking facility, said cart-marking system computer using said third set of instructions to generate an identification mark to be placed on said cart.

21. The method of claim 20, wherein said identification mark includes information indicating one or more members selected from the group consisting of the number of bread packages to be placed on said cart, the type of bread product to be placed on said cart, the brand of bread to be placed on said cart, and the retail destination for said cart.

22. The method of claim 21, wherein the identification mark is a bar code.

23. The method of claim 19, wherein, based on input data relating to production and demand, an onsite computer at the baking facility generates a fourth set of instructions reflecting the baking facility's daily production and packaging schedule, and the operation of each of said bagging system and said coupon-targeting system is further based on said fourth set of instructions.

24. The method of claim 19, wherein, based on input data relating to production and demand, a baking facility central computer system generates a fourth set of instructions reflecting the baking facility's daily production and packaging schedule, and the operation of each of said bagging system and said coupon-targeting system is further based on said fourth set of instructions.

25. The method of claim 19, wherein the promotional specifications are electronically transmitted from the client's computer.

26. The method of claim 19, wherein the purchase-order information is transmitted from a route driver's computer.

27. The method of claim 19, wherein the first set of instructions includes data to specify the wrapper to be used for bagging the bread product.

28. The method of claim 19, wherein said bread product is a member selected from the group consisting of sliced bread, unsliced bread, hamburger buns, hotdog buns, and tortillas.
